(19) United States
(12) Patent Application Publication
(10) Pub. No.: US 2017/0028494 A1
(43) Pub. Date: Feb. 2, 2017

(54) APPARATUS AND METHOD FOR SOLDERING JOINING PARTNERS, SAID APPARATUS COMPRISING A VACUUM CHAMBER AND PLATE ELEMENTS

(71) Applicant: CENTROTHERM PHOVOLTAICS AG, Blaubeuren (DE)

(72) Inventors: Matthias Usenbenz, Heroldstatt (DE); Reinhard Lenz, Blaubeuren (DE)

(21) Appl. No.: 15/300,818

(22) PCT Filed: Mar. 31, 2015
(86) PCT No.: PCT/EP2015/057090

§ 371 Date: Sep. 30, 2016

(30) Foreign Application Priority Data
Apr. 1, 2014 (DE) 10 2014 004 728.8

(51) Int. Cl. B23K 1/008; B23K 3/08; B23K 1/005

(52) U.S. Cl. CPC B23K 1/008; B23K 1/0053; B23K 3/087; B23K 2201/36

(57) ABSTRACT

The invention describes an apparatus and a method for soldering mating parts, in particular electrical components to circuit boards or other carrier elements. The mating parts may be received and pressed together between two plate elements. One of the plate elements, which is heatable, may be flexible and may be elastically biased in the direction of the other plate element, by means of a plurality of elastically biased elements. Alternatively or additionally, heating may be provided for both plate elements.

### RELATED APPLICATIONS

This application corresponds to PCT/EP2015/057090, filed Mar. 31 2015, which claims the benefit of German Application No. 10 2014 004 728.8, filed Apr. 1, 2014. The subject matter of these applications is, of which are incorporated herein by reference in its entirety.

### BACKGROUND OF THE INVENTION

The present invention relates to apparatuses and a method for soldering mating parts, in particular electronic components, to circuit boards or other carrier elements.

In the art different methods and apparatuses for soldering mating parts and in particular for soldering electronic components to substrates are known. It is common to perform the soldering in a vacuum.

For example, EP 1 474 260 B1 discloses a multi-chamber vacuum solder system, in which substrates as a first mating part are positioned on a substrate carrier, which is typically formed as a massive rigid plate, and wherein an electrical component as a second mating partner is placed on the substrate. A suitable solder material is provided between the mating parts substrate/component as a pre-form or as a paste. The substrate carrier is subsequently heated in a vacuum chamber by means of lamp radiation, which is generated outside the vacuum chamber and transmitted into the same. The substrate carrier then heats the substrate via thermal conduction to a temperature which is sufficient to melt the solder material to thereby solder the mating parts.

In such systems, the problem may arise, that the thermal conductivity between the substrate carrier as a support and the substrate is disrupted and that therefore the solder result is not reproducible. Such a disruption of the thermal conduction may, for example, occur when the substrate and/or the substrate carrier are uneven, such that only punctual contacts between the substrata and substrate carrier are given, via which the thermal conduction may occur.

In particular, with large area substrates, this may lead to inhomogeneous heating of the substrate, such that areas may arise in which the solder is not or not completely molten and the soldering result is poor. But also with a plurality of smaller substrates having correspondingly smaller components as mating parts, it is possible that corresponding inhomogeneities with respect to the temperature distribution occur between neighbouring substrates, such that no homogenous soldering results can be achieved. When using a rigid state, furthermore the problem may arise that the plate deforms more and more over time and such deformation may lead to a shortened lifetime, because the deformation may necessitate replacement of the plate when the deformation reaches a certain level.

In such systems, the contact pressure between the mating parts is furthermore only dependent on the weight of the upper mating part, such that occasionally a poor connection or joint is formed between the mating parts, in particular in cases where the solder between the mating parts is not sufficiently heated. A further problem which may occur in these systems is that the upper mating part typically is heated to a temperature which is below that of the solder material, which may impair the solder joint. In particular, this may lead to cold soldering points, which lead to a poor joint.

### SUMMARY OF THE INVENTION

It is therefore an object of the present invention to provide apparatuses and a method for soldering of mating parts, which may reduce or overcome one or more of the above-referenced problems.

In accordance with the present invention, this object is achieved by an apparatus according to claim 1, a method according to claim 10 or an apparatus according to claim 13. Further embodiments are inter alia disclosed in the respective dependent claims.

In particular, an apparatus for soldering mating parts, such as electrical components to circuit boards or other carrier elements is provided, the apparatus comprising: a vacuum chamber, which is connective to a vacuum unit, a first plats element in the vacuum chamber, a second plate element in the vacuum chamber, which is moveable between an open position and a closed position, wherein the second plate element in the closed position is arranged opposite the first plate element, in order to be able to press together mating parts, which are received between the plate elements, wherein one of the plate elements is flexible and the other is rigid, a plurality of elastically biased elements, which are capable of contacting and elastically biasing the flexible plate element towards the other plate element, and at least one first heating unit, which is capable of heating the flexible plate element. Such an apparatus having a flexible plate element inter alia enables an adjustment to unevenness of the mating parts, which may inter alia improve the soldering of uneven large area substrates or of individual substrates having different heights or tolerances with respect to their heights. A warping of one of the plate elements due to ageing plays a minor role doe to the adaptability of the flexible plate element. The quality of the solder joint may increase due to a better heat transfer between the flexible plate element and the mating partner(s) which are in contact herewith and may thus lead to a better reproducibility of the process result. Furthermore, the selective pressing power which may be applied to the mating partners leads to a good solder joint.

In a preferred embodiment, the apparatus comprises a second heating unit, which is capable of heating the other heating element, which the second heating unit is controllable independent of the first heating unit. Hereby, both mating parts may be heated, and thereby cold solder points may be prevented. In particular, due to the individual drivability, different temperatures may he applied to the mating parts, which may enhance the soldering of mating parts having different heat capacities or other different thermal characteristics.

Preferably, the plurality of elastically biased elements is moveably guided in a base plate and biased by at least one spring. This leads to a simple construction and further provides good functionality at the used temperatures.

The first heating unit preferably comprises at least one irradiation heater, in particular in the form of a heating lamp, which has a fast response characteristic. The heating unit is preferably arranged between the base plate and the flexible plate element and may thus act directly on the flexible plate element. For achieving the flexibility, the flexible plate element preferably has a small thickness of ≦5 mm, preferably ≦2 mm and thus also a small thermal mass, such that the flexible plate element also quickly responds to the radiation heating of the heating unit.

In an embodiment the apparatus comprises a moving unit which is ID capable of moving the plurality of elastically biased elements and thus the flexible plate element in a direction towards the other plate element. Such a movement enables pressing the mating parts together between the plate elements with a single movement, wherein the elastic bias provides a balance of the pressing power over the flexible plate element. Preferably, the movement is achieved via the base plate, in which the elastically-biased elements are supported.

For a good positioning of the mating parts with respect to each other, at least one of the plate elements comprises at least one positioning recess for at least partially receiving one of the mating parts. Preferably, both plate elements comprise respective positioning recesses, in particular when a plurality of smaller mating parts are to be soldered conjointly.

In a preferred embodiment, the flexible plate element is made of graphite and/or has a thickness of ≦2 mm. Graphite has a good thermal stability and for most processes does not represent a contamination and furthermore has a sufficient flexibility at a corresponding thickness. The thickness should for example be in the range between 1 and 2 mm for a plate element having a base surface corresponding to the A3-format, wherein a graphite plate may not necessarily be in a position to compensate for erratic height differences.

The vacuum chamber may be configured such that it comprises at least one bottom part and a cover which is moveable with respect to the bottom part, wherein the rigid plate element is mounted to the cover and the flexible plate element is mounted to the bottom part. Such a configuration enables a simple construction as well as simple opening and closing of the vacuum chamber. Preferably, the rigid plate element has a vacuum holding unit for holding at least one mating part, in particular a plurality of mating parts. Such a holding unit, for example, enables loading of both plate elements as well as holding the mating parts prior to mating or contacting the same in a spaced relationship.

In the method for soldering mating parts, in particular electrical components to a circuit board or another carrier element, the following is provided: positioning the mating parts with a solder material therebetween with respect to each other in a vacuum chamber, such that the mating parts are arranged between first and second plate elements, wherein one of the plate elements is flexible and the other plate element is rigid, and wherein a plurality of elastically biased elements are in contact with the flexible plate element, in order to elastically support the flexible plate element in the contact areas, generating a vacuum in the vacuum chamber, moving at least one of the plate elements into the direction of the other plate element to press the mating parts together between the plate elements, wherein the flexible plate element is at least partially deformed, in order to achieve good contact to at least one of the mating parts, and heating at least the flexible plate element and thereby the mating part being in contact therewith to a temperature, which is sufficient to melt the solder material. Such a method enables the advantages set forth above.

Preferably, also the rigid plate element and thus the mating part being in contact herewith are heated, wherein the heating of the rigid plate element may be independent of the heating of the flexible plate element. Hereby, cold soldering points may be prevented.

For a fast response characteristic during the heating, the flexible plate element is heated via radiation heating, in particular via a plurality of heating lamps.

An independent alternative apparatus for soldering of mating parts, in particular electrical components to circuit boards or other carrier elements, comprises: a vacuum chamber, which is connective to a vacuum unit, a first plate element in the vacuum chamber, a second plate element in the vacuum chamber, which is moveable between an open position and a closed position, wherein the second plate element in the closed position is opposed to the first plate element, in order to be able to press mating parts arranged between the plate elements together, at least a first heating unit, which is capable of heating the first plate element and at least a second heating unit, which is capable of heating the second plate element, wherein the second heating unit it independently controllable from the first heating unit. Such an apparatus provides good heating of the mating parts and may prevent the occurrence of cold soldering points. This apparatus may preferably be combined with the features of the previously described apparatus. Also a method corresponding to this apparatus may be provided, wherein independently of a flexible plats, mating parts to be soldered are pressed together between plate elements, which are both heated. Such both sided heating may in particular be advantageous prior to and while pressing the mating parts together.

### BRIEF DESCRIPTION OF THE DRAWINGS

The invention will be described in more detail herein below with reference to the drawings; in the drawings:

FIG. 1 is a schematic perspective view of a vacuum-solder apparatus in an open condition;

FIG. 2 is a schematic cross-sectional view of the vacuum-solder apparatus of FIG. 1 in the open condition;

FIG. 3 is a schematic cross-sectional view of the vacuum-solder apparatus of FIG. 1 in a closed condition prior to a solder process;

FIG. 4 is a schematic cross-sectional view of the vacuum-solder apparatus of FIG. 1 in the closed condition during a solder process; and

FIG. 5 is a schematic sectional view of the vacuum-solder apparatus of FIG. 4 along a sectional plane, which is perpendicular to the sectional plane of FIG. 4.

### DESCRIPTION

Location and directional references as used in the following description primarily refer to the representation in the drawings and should therefore not be seen as limiting, wherein they may refer to a preferred final arrangement of the elements.

The figures show different views of the vacuum-solder apparatus 1, which is configured for conjointly soldering a plurality of pairs of mating parts. The vacuum-solder apparatus 1 may also be used for soldering a single pair of large area mating parts or of a large area mating part with a plurality of smaller mating parts.

The vacuum-solder apparatus 1 in substance consist of a moveable cover 3 and a stationary bottom part 5, which are connected to each other via a pivot mechanism 7, as well as a solder unit 9.

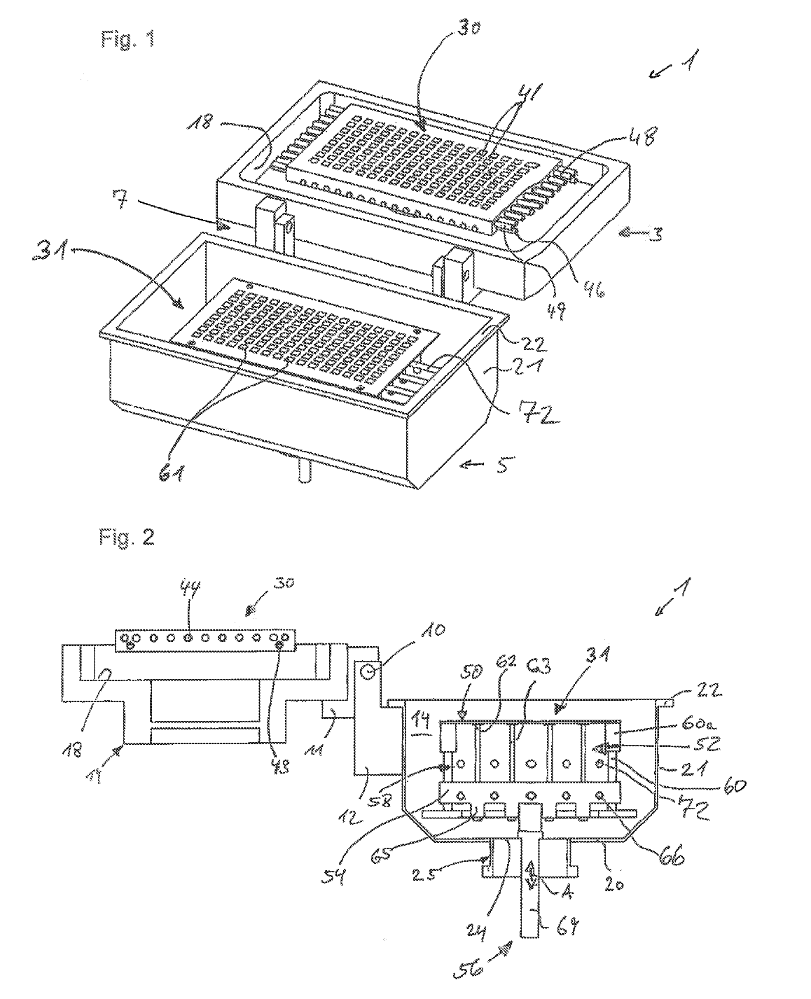

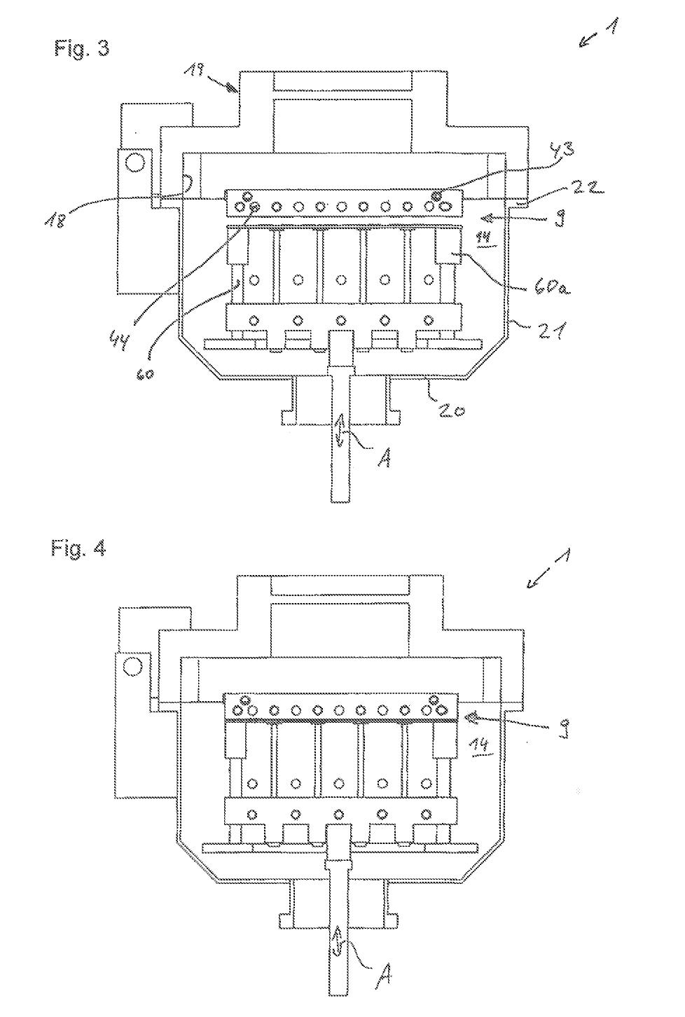

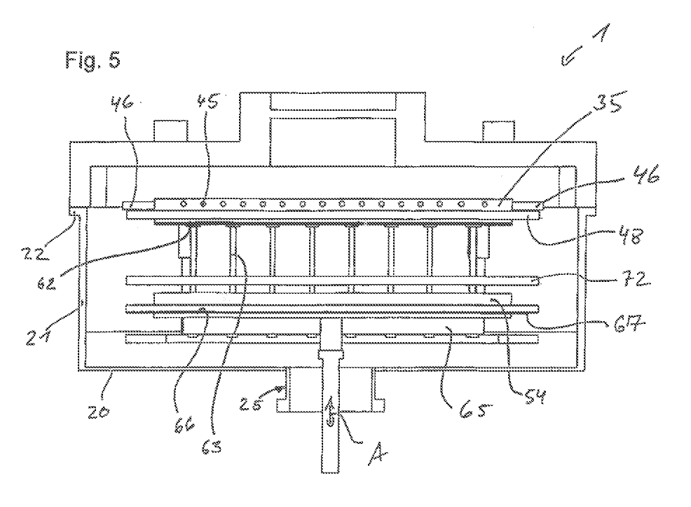

The pivot mechanism 7 is constructed such that the cover 3 may pivot by approximately 180° with respect to the bottom part 5 between an open position (see FIGS. 1 and 2) and a closed position (see FIGS. 3 to 5).

The pivot mechanism is in substance formed by simple pivot pins 10, which are pivotally received in respective flanges 11, 12 at the cover 3 and the bottom part 5, respectively. In the presentation, two pivot pins 10 and respective flanges 11, 12 are shown. However, other pivot mechanisms are possible, wherein also a pivotal movement of less of a 180° may be considered. Also, a linear movement between the cover 3 and the bottom part 5 for opening/closing may be considered. In a closed condition, the cover 3 and the bottom part 6 form a vacuum-solder chamber 14, which may be pumped in a suitable manner via a not shown sub-atmospheric pressure source (not shown), such as a vacuum pump, to a suitable sub-atmospheric pressure. The sub-atmospheric pressure source may be fluidly connected to the vacuum-solder chamber 14 via the at least one of the cover 3 and the bottom part 5. However, a connection via the bottom part 5 is preferred as shown in the embodiment since the bottom part 5 is formed as a stationary part.

In a top view, the cover 3 has a substantially rectangular shape. In the lower side of the cover 3 a recess 18 is formed and on the upper side, a central, protruding flange 19 is formed via which for example the connection to one or more external supplies may be made as will be explained in more detail herein below.

The bottom part 5 also has a substantially rectangular shape in a top view thereof, corresponding to the shape and size of the cover 3. In a sectional view, the bottom part 5 has a bowl shape having a bottom 20 and side walls 21, which at their upper ends comprise a circumferential support flange 22 for the cover 3. In the area of the support flange 22 of the bottom part 5 or at corresponding contact surfaces of the cover 3, sealing means may be provided as the skilled person will realize. In the bottom 20 an opening 24 is provided, which is radially surrounded by a downwardly protruding flange 25. On the one hand, the opening may act as a passage for a lift mechanism, which will be explained in more detail herein below, but on the other hand, it can also be used as an attachment for the sub-atmospheric pressure source or for other external supplies.

The solder unit 9, which is arranged in the vacuum-soldering chamber 14, when the vacuum-soldering apparatus 1 is in the closed condition, comprises a first subunlt 30 mounted to the cover 3 and a second subunlt 31 mounted to the bottom part 5.

The subunit 30 in substance consists of a plate element 35, an optional holding unit and a heating/cooling unit. The plate element 35 is a rigid plate, which is partially received in the recess 18 and which is fixedly mounted to the cover 3. The plate element 35 has a first side 40 facing away from the cover 3 and protruding from the recess 18 in the cover. In a closed condition of the cover 3, the side 40 faces downward and is in substance horizontally aligned. In the side 40 a plurality of recesses is formed, which form receiving pockets 41 for respectively receiving a mating part such as an electrical component. In the drawings, 128 receiving pockets 41 are shown for a side 40 having for example an A3 format. Obviously, a different number of receiving pockets 41 may be provided or the receiving pockets may be dispensed with, in particular when large area mating parts are to be soldered.

In the plate element 35 two passages 43 as well as a plurality of passages 44 are formed, which each extend in a longitudinal direction of the plate element 35. The inner sides of the passages 43 are respectively connected to a plurality of cross bores 45, which are connected to not shown openings in the side 40, in particular in the receiving pockets 41, via conduits, which are also not shown. The passages 43 are connected via conduit elements 46 with a pressure/sub-atmospheric pressure source (not shown), such that a positive pressure or a sob-atmospheric pressure may be applied to the openings in the side 40. Hereby, by means of sub-atmospheric pressure, a holding force may be applied to the respective mating parts in the area of the opening and/or a positive pressure (a pressure impulse) may be applied to provide secure release of the mating part from the plate element 35. The pressure/sub-atmospheric pressure source, the conduit elements 46, the passages 43, the cross bores 46 and the conduits together with the not shown openings in the side 40 together form the optional holding unit.

The passages 44 are arranged in a plane in the plate element 35, which is closer to the side 40 than a plane extending through the passages 43. In the figures, eleven passages 44 are provided, although a different number may also be provided. The passages 44 each serve to receive a heating element 48 or a cooling fluid conduit 49 and they thus form part of the heating/cooling unit. In FIGS. 2 to 5, the thinner circles show a beating element 48, while the thicker circles show a cooling fluid conduit 49. As shown, in the passages 43 heating elements 48 and cooling fluid conduits 49 are received in an alternating manner. In the representation, five heating elements 48 and six cooling fluid conduits 49 are provided. Obviously also a different arrangement of heating elements 48 and cooling fluid conduits 49 is possible.

As heating elements 48, for example resistance heating elements are taken into consideration. It is also possible to use other types of heating elements. In particular it would also be possible to use simple conduits as heating elements, which are fluidly connected with a source of a hot fluid. For healing the plate elements 45, a hot Hold could be passed through the conduits. In such an embodiment, it would also be possible to subsequently pass a cooler fluid through the conduits for cooling the plate element 35, in the same manner as is done with cooling fluid conduits 49. In such a case, it would in particular be possible to use ail conduits as combined heating/cooling conduits. Currently, however, it is preferred to use resistance heating elements as heating elements 48, since such elements can quickly generate the required temperatures.

The cooling fluid conduits 49 are fluidly connected with a source of a cooling fluid in a suitable manner, which is not shown, wherein such a connection (as well as an electrical connection for the resistance heating elements) may for example be achieved via the flange 19.

The subunit 31 of the soldering unit 9 in substance consists of a flexible plate element 50, a plurality of support elements 52 for the plate element 50, a base plate 54, a lifting unit 56 for the base plate 54, a heating unit 58 and a cooling unit.

The flexible plate element 50 is made of a suitable material, which, during the soldering, does not introduce contaminations into the process, and which has a sufficient thermal stability at the soldering temperatures, which typically range between 350° C. and 500° C. Furthermore, the material is to be designed such that it has a certain flexibility, which over the surface thereof allows for example a heights adjustment of 1 to several Millimetres. In the presently preferred embodiment, the plate element is a graphite plate having an A3 format and a thickness of ≦2 mm. The flexible plate is placed en support posts 60 of the bottom part 5, which are arranged in a suitable manner in the bowl shaped inner space of the bottom part 5. Four of these support posts 60 are provided, which together form a horizontal support plane for the flexible plate element 50. The support posts 60 may each comprise a guide at their upper ends, which works together with a guide at the flexible plate element 50, in order to ensure an exact positioning of the two elements with respect to each other and to allow a guided lifting off of the flexible plate element 50 from the support posts 60. In the figures, guide sleeves 60a are shown which are fixedly mounted to the underside of the flexible plate element 50, and which are guided on the support posts 60 in a vertical direction. Via the guide sleeves 60a, an exact positioning of the flexible plate element 50 in the bottom part and an exact guiding during a vertical movement is possible. The skilled person will realize that other types of guides are possible. For example, the support posts 60 may have vertical guide bores, into which respective guide pins, which are connected to the flexible plate element 50 may extend.

The flexible plate element 50 has a plurality of recesses in the upper side, facing away from the bottom part for forming receiving pockets 61, corresponding to the receiving pockets 41 in plate element 35. Hence, in the shown embodiment 128 receiving pockets 61 are provided. Again, depending on the application, a different number may be provided and it is also possible that the receiving pockets 61 are dispensed with. It is also possible that the flexible plate element 50 has guides for a matrix having cut-outs for forming receiving pockets, such that a change of the matrix quickly enables different configurations of receiving pockets to be provided. The receiving pockets 61 (or also 41) may for example have a depth of 0.5 mm. At its underside, the flexible plate is in contact with the support elements 52. This contact may be a fixed contact or a loose contact.

The support elements 52 each have a support portion 62 and a post or shaft portion 63. The support portion 62 and the shaft portion 63 are each made of a temperature resistant material, which does not introduce contaminations into the soldering process, such as graphite. They may also be made of another suitable material. The support portions 62 are each mounted in a suitable manner to an upper end of the respective shaft portions 63 and on their upper side they form a horizontal support surface. In the embodiment as shown, 32 support elements are provided. These are arranged with respect to the flexible plate element 50 such that in each case one support element/support portion is arranged in an area of projection of the corners of four receiving pockets 61.

The shaft portions 63 each extend between the base plate 54 and the flexible plate element 50. The shaft portions 63 are arranged in guides of the base plate 54 and are slidably supported by the guides in the base plate 54. Elastic biasing elements are provided in the area of the guides in the base plate 54, such as springs, in order to bias the shaft portions upwards (out of the guides). The movement of the shaft portions may be limited by suitable slops. The biasing elements are preferably of the type that provides a substantially constant force over their stroke.

The base plate 54 has a substantially rectangular shape in a top view thereof, corresponding to the shape of the flexible plate 50. The above referenced guides are vertically extending in the base plate for movabiy supporting the shaft portions 63 and to house the respective biasing elements, in the area of the guides, the base plate 54 comprises respective projections 65 on its lower side, which form extensions of the guides and provide sufficient room for receiving the biasing elements. Hereby, the thickness of the base plate 54 (with the exception of the projections 65) may be held relatively small. At the underside of the projections 65, adjustment elements, such as screws for positioning the biasing elements within the guides may be provided in a known manner. Via these elements the biasing force may be adjusted.

Besides the guides for the shaft portions 63 of the support element 52, the base plate also comprises vertical guide openings for the support posts 60, in order to allow an up and down movement of the base plate 54 along the support posts 60.

A plurality of (here five are shown) through openings 66 are provided, which horizontally extend through the base plate 54 in a longitudinal direction thereof. The through openings 66 may be supplied with a cooling fluid via a supply duct 67 and an external cooling fluid supply (not shown), in order to cool the base plate 54 during operation. These elements together form the cooling unit 59. The upper side of the base plate 54 comprises a reflective coating or is inherently made reflective. At its lower side, the base plate 54 is connected to a lifting unit 56, which for simplification of the drawings is shown as a shaft 69, which is movable in the direction of the double headed arrow A in a manner which is not shown in detail. Such lifting devices are known to the skilled person. The lifting device thus allows a movement of the base plats 54 in a vertical direction and thereby also allows respective movement of the flexible plate element 50 (via the support elements), as will be explained in more detail herein below. The passage of the shaft 69 is for example sealed to the environment in a suitable manner via a bellows unit.

The heating unit 58 of the subunlt 31 is made up of a plurality of (here five) elongated heating elements 72, which are formed as radiation heaters in the form of heating lamps, such as tungsten-halogen lamps. The heating elements 72 extend into the space between the base plate 54 and the flexible plate element 50 between the support elements 52. The heating elements emit heat radiation, which is absorbed by the flexible plate element 50 in order to heat the same. For a good absorption of the heat radiation, the flexible plate element 50 may comprise a specific coating or the surface facing the lamps may be roughened. As previously mentioned, the upper side of the base plate 54 may be specifically made reflective, in order to keep the absorption of heat radiation small. The heat radiation may possibly be specifically reflected towards the flexible plate element 50 by a corresponding structure of the surface of the base plate 54. Correspondingly, also the inner faces of the bottom part 5 may be coated with a reflective material or may inherently be formed to be well reflecting (for example by a respective polishing of the base material).

In the following, operation of the vacuum-soldering apparatus 1 will be explained with reference to the drawings.

The vacuum-soldering apparatus 1 is initially in an open condition (see FIGS. 1 and 2) and will be loaded with mating parts. For example, electrical components will be placed in the receiving pockets 41 in the plate element 35 and substrates to be soldered with the electrical components are placed in the receiving pockets 61 in the flexible plate element 50. A solder material is placed on the substrates for example as a pre-form or as a paste. By applying sub-atmospheric pressure to the electrical components in the receiving pockets 41 via the optional holding unit, the electrical components may be held in a secure manner to the plate element 35.

After loading, the cover 3 is pivoted into the closed position (FIG. 3). Hereby, the mating pads are arranged opposite each other in pairs. The base plate 54 is in a lowered position at this point in time such that the mating parts are held spaced from each other.

In this condition, the vacuum-soldering chamber 14 is for example pumped to a pressure of approximately 100 Millibar via the sub-atmospheric pressure unit, which is not shown. Subsequently, the vacuum-soldering chamber 14 is flooded with nitrogen and then again pumped to a lower pressure. This cycle may be repeated several times, in order to remove any contaminants from the chamber. For the actual soldering process the vacuum-soldering chamber 14 may be filled with nitrogen.

When a desired atmosphere is present in the vacuum-soldering chamber 14, the flexible plate element 50 is heated via the heating elements 72 by means of radiation. The flexible plate element 50 can then heat the substrates (lower mating parts) and the soldering-material placed thereon by means of thermal conduction. Additionally, the components (upper mating parts) are heated via the heating elements 48 in the plate elements 35. Hereby, the mating parts may be heated to different temperatures in a desired manner. In particular, the substrates (lower) mating parts may be heated to a higher temperature compared to the components (upper mating parts). Hereby, the substrates are to be heated at least to a temperature at or above the melting point of the solder material. For the components, heating to a temperature, which is sufficient to avoid cold solder points is sufficient. For example, the flexible plate element 50 (and via the plate element 50, the substrates) may be heated to a temperature of 450° C. and the upper plate element 35 (and via the plate element 35, the components) may be heated to a temperature of approximately 250° C. During the heating of the flexible plate element 50, the base plate 54 may be actively cooled, in order to avoid heating thereof, which could impair the guiding of the support elements 52. During or preferably already before the heating of the plate elements 35, 50 (and thus the mating parts) the base plate 54 is lifted via the lifting unit 56. Hereby, the support portions 62 of the support elements 52 are being brought into contact with the backside of the flexible plate element 50 (if there are not in continuous contact therewith) and the flexible plate element 50 is moved in a vertical direction upwards towards the plate element 35. Thereby, the mating parts are pressed together. The movement of the base plate 54 is such that the supporting elements 52 at least partially compress the not shown biasing elements in the base plate, such that the pressing power between the mating parts is at least partially determined by the bias of the biasing elements. By means of the flexible plate element 50 it is possible that an unevenness in the upper plate element 35 and/or manufacturing tolerances of the mating parts are at least partially compensated for. A deformation of the flexible plate element 50 thus enables a homogeneous pressing together of the mating parts and furthermore ensures good contact and thus a good thermal conduction between the flexible plate element 50 and the substrate. Hereby, a homogeneous heating of the substrate and a homogeneous melting of the soldering material is achieved.

The mating parts are pressed together for a suitable time, such that the mating parts are soldered together. Subsequently, the sub-atmospheric pressure applied to the components may be released in order to release the components from the upper plate element 35. Such a release may be further supported by a small pressure impulse. The respective heating elements 48, 72 may be switched off and the upper plate element may for example be cooled by introducing a suitable cooling medium into the cooling fluid conduits 49. Hereby, the cooling should not be too strong, in order to avoid excessive thermal stress within the plate element 35. In this context, it is taken into consideration to first pass a flow of pressurized air and later a liquid cooling medium through the cooling fluid conduits 49.

The base plate 54 and hereby the flexible plate element 50 may now again be lowered, wherein the mating parts together are supported by the flexible plate element 50. The chamber may again be evacuated and flooded with nitrogen to be subsequently opened, in order to unload the soldered mating parts.

In the description above, a plurality of mating parts was conjointly soldered in the vacuum-soldering apparatus 1. As previously mentioned, the apparatus is also advantageously usable for large area mating parts, wherein the flexible plate element 50 may ensure that the surfaces of the mating parts are pressed together in a homogeneous manner and that a homogeneous contact is provided for thermal conduction. In the above description, the flexible plate element 50 remains in the vacuum-soldering apparatus 1 during loading and unloading. It is, however, also possible, to remove the flexible plate element 50 from the vacuum-soldering apparatus 1 for the loading and unloading and to place it back into the vacuum-soldering apparatus 1 for the respective soldering process.

When the optional holding device in the area of the upper plate element 35 is dispensed with, during the loading, the mating parts may for example be placed onto the flexible plate element 50 such that they lie on top of each other having the soldering material therebetween.

The heating unit for the upper plate element 35 can also be advantageously used in a vacuum-soldering apparatus irrespective of the use of the flexible plate element 50.

The above apparatus and the described soldering method with the flexible plate element 50 inter alia enable an adjustment to an unevenness or heights differences of the mating parts. This inter alia enables soldering of uneven large area substrates or of individual substrates of different heights or tolerances. A deformation of the plates which may occur with age plays a subsidiary role due to the adjustability of the flexible plate element 50. The quality of the solder joint increases due to a homogeneous temperature transfer between the flexible plate element 50 and the respective lower mating part(s) and thereby enables a better reproducibility of the processed result. Any warping of the upper plate element 35 which may occur with an increasing number of process cycles may be taken up by the flexible plate element 50 up to a certain degree. Furthermore parts having different heat capacities or different thermal characteristics may be soldered together.

The invention has been described with respect to preferred embodiments of the invention without being limited to the specific embodiments. In particular, in connection with the flexible plate element heating of the rigid plate element may be dispensed with and similarly, the holding device connected thereto, may be dispensed with, such that the rigid plate element only acts as a counter surface for pressing the mating parts together. With both sided heating, it is also possible to dispense with the elastic plate element and to possibly work with two rigid plate elements. These should preferably be elastically biased towards each other.

1. An apparatus for soldering mating parts, in particular electrical components to circuit boards or other carrier elements, the apparatus comprising:
a vacuum chamber, which is connective to a vacuum unit;
a first plate element in the vacuum chamber;
a second plate element in the vacuum chamber, the second plate element being moveable between an open position and a closed position, wherein the second plate element in the closed position is arranged opposite the first plate element, in order to be able to press together mating parts, which are received between the plate elements, wherein one of the plate elements is flexible and the other one is rigid;
a plurality of elastically-biased elements, which are capable of contacting the flexible plate element, and to elastically bias the flexible plate element towards the other plate element, and
at least one first heating unit, which is capable of heating the flexible plate element.

2. The apparatus of claim 1 further comprising a second heating unit which is capable of heating the other plate element, wherein the second heating unit is controllable independent of the first heating unit.

3. The apparatus of claim 1, wherein the plurality of elastically-biased elements is moveably guided in a base plate and biased by at least one spring.

4. The apparatus of claim 1, wherein the first heating unit comprises at least one radiation heater, in particular in the form of a heating lamp.

5. The apparatus of claim 1, further comprising a moving unit, which is capable of moving the plurality of elastically biased elements and thus the flexible plate element in a direction towards the other plate element.

6. The apparatus of claim 1, wherein at least one of the plate elements comprises at least one positioning recess for at least partially receiving one of the mating parts.

7. The apparatus of claim 1, wherein the flexible plate element is made of graphite and/or has a thickness of ≦2 mm.

8. The apparatus of claim 1, wherein the vacuum chamber comprises at least one bottom part and a cover which is moveable with respect to the bottom part, wherein the rigid plate element is mounted to the cover and the flexible plate element is mounted to the bottom part.

9. The apparatus of claim 1, wherein the rigid plate element has a vacuum holding unit for holding at least one mating part in particular a plurality of mating parts.

10. A method for soldering mating parts, in particular electrical components to a circuit board or another carrier element, the method comprising:
positioning the mating parts with a solder material therebetween with respect to each other in a vacuum chamber, such that the mating parts are arranged between first and second plate elements, wherein one of the plate elements is flexible and the other plate element is rigid, and wherein a plurality of elastically biased elements is in contact with the flexible plate element in order to elastically support the flexible plate element in the contact areas;
generating a vacuum in the vacuum chamber;
moving at least one of the plate elements into the direction of the other plate element, in order to press the mating parts together between the plate elements, wherein the flexible plate element is at least partially deformed, to achieve good contact to at least one of the mating parts;
and heating at least the flexible plate element and thereby the mating pad being in contact therewith to a temperature, which is sufficient to melt the solder material.

11. The method of claim 10, wherein also the rigid plate element and the mating part being in contact herewith are heated, wherein the heating of the rigid plate element may be independent of the heating of the flexible plate element.

12. The method of claim 10, wherein the flexible plate element is heated via radiation heating, in particular via a plurality of heating lamps.
